(19) United States
(12) Patent Application Publication
(10) Pub. No.: US 2013/0317871 A1
(43) Pub. Date: Nov. 28, 2013

(54) METHODS AND APPARATUS FOR ONLINE SOURCING

(71) Applicant: MobileWorks, Inc., Berkeley, CA (US)

(72) Inventors: Anand Kulkarni, Berkeley, CA (US); Philipp Gutheim, Berkeley, CA (US); Prayag Narula, Berkeley, CA (US); David Rolnitzky, Denver, CO (US); Lionel Barrow, Berkeley, CA (US)

(73) Assignee: MobileWorks, Inc., Berkeley, CA (US)

(21) Appl. No.: 13/875,782

(22) Filed: May 2, 2013

Related U.S. Application Data
(60) Provisional application No. 61/641,573, filed on May 2, 2012.

(51) Int. Cl. G06Q 10/06

(52) U.S. Cl. CPC G06Q 10/063112
USPC 705/7.14

(57) ABSTRACT

A system, method, and article of manufacture for online crowd-sourcing and for communicating with a requester and with several of workers, the system includes a central controller that communicates with each requester via an interface, to receive the task(s) to be performed and to provide a response for that task(s), and with each worker via an interface, to deliver task assignments and to receive responses, the central controller further including a task assignment system that is structured and arranged to insert tasks to be performed into a priority queue multiple times and to push a next task in the priority queue to a selected worker based on information about the selected worker; and a data storage device for storing information about workers that includes a worker identification, a worker skill level, a worker accuracy rating, a list of historical tasks performed by the worker, and a list of historical tasks that the worker has not performed.

### CROSS-REFERENCE TO RELATED APPLICATIONS

This application claims priority to and the benefit of U.S. Provisional Patent Application No. 61/641,573 filed on May 2, 2012, which is incorporated herein in its entirety by reference.

### TECHNICAL FIELD

The invention relates to online services employing human computation platforms and, more specifically, to online services that place requested tasks in a priority queue and then push the queued tasks down to a crowd of qualified workers.

### BACKGROUND OF THE INVENTION

Human computation platforms are online services that allow software systems and businesses to delegate portions of their functionality or operations to crowds of human workers over a network, e.g., the World Wide Web, the Internet, and so forth. Amazon's Mechanical Turk (AMT) is one example of such a service. AMT is a Web-based marketplace in which clients post a task(s) offering a fee, which is usually nominal, for accomplishment of the task(s). AMT workers, or “Turkers”, browse the posted taskings, selecting and performing tasks that are not only within their education and capabilities but also provide sufficient remuneration to make it worth the Turker's time and effort. The number of Turkers working on postings is estimated at over 200,000, of which approximately 56 percent reside in the United States and 36 percent reside in India.

In such a marketplace, problems associated with designing effective tasks that are understandable and not ambiguous, filtering out unqualified or under-qualified Turkers, and eliminating erroneous responses are left up to the poster. As a result, each poster must build a quality control infrastructure on top of narrowly-constrained application domains, such as audio transcription, Web research, text recognition, and the like and, moreover, must employ domain-specific techniques to deal with possible errors from the crowd.

A substantial body of literature focuses on how to reduce worker error during human computation. Early human computation work used redundancy to control error, which is to say that the same microtask was provided to multiple workers. However, although redundancy works well in mitigating human error, it is vulnerable to structural confusion in tasks and to worker collusion. Other approaches have layered redundancy with tracking a worker's historical performance and/or with on-going worker assessment on so-called “gold standard” tasks whose answers are known in advance. However, historical performance is readily gamed in open marketplaces and may not adequately predict worker performance on unfamiliar tasks. Additionally, it can be hard to define a “gold standard” for tasks that do not involve a single correct answer, e.g., content creation.

More sophisticated approaches to online crowd-sourcing use workflow to divide complex tasks into various short-duration sub-tasks that can be distributed among multiple workers. These approaches may also include any one of: a peer review step that allows selected workers to verify that another worker's edits were carried out correctly; allowing workers to assist in designing workflows for complex tasks; and displaying worker-to-worker or requester-to-worker feedback immediately after a task has been completed. However, improper allocation of workers and tasks within a particular workflow can reduce quality of results.

Some factors that impact who is assigned to a workflow and who performs which task include: education, access to a processing device, e.g., a personal computer, and, having a means of access, the ability to locate tasks in the online marketplace. Indian Turkers, for example, as a group, are more educated, earn higher wages, and enjoy a higher standard of living than the average Indian citizen. Those at the bottom of the economic pyramid, however, have little chance to make a better life for themselves by performing tasks that they might otherwise be able to accomplish because of, e.g., their lack of access to a processing device.

The prevalence, capabilities, and relative cost of mobile or cellular telephones (collectively, “cellphones”) vis-à-vis personal computers demonstrate that the mobile Internet is a cost-effective way to transmit microtasks to people that do not traditionally participate in the business of crowdsourcing. The use of cellphones to distribute microtasks, i.e., mobile crowd-sourcing, has been explored by others. For example, TxtEagle, which was deployed in Kenya, uses SMS text messaging to distribute microtasks that involve, for example: audio transcription, local language translation, and market research. SamaSource, on the other hand, uses outsourcing centers where workers are actively managed instead of mobile crowd-sourcing.

Human computation systems are typically assessed on their ability to provide accurate results, which refers to the timely and correct completion of a posted task(s). Thus, accuracy is among the many challenges of mobile crowd-sourcing. Human computation systems may provide inaccurate or no results for one of several reasons: human error, task specification problems, and the incentive problem, etc. The latter two problems are interrelated in that if a potential worker does not understand an ambiguous task or does not feel that the compensation warrants his/her efforts, the worker may not undertake the work. Many tasks posted to online marketplaces languish and are never solved simply because potential workers cannot understand the task and/or view the reward as inadequate. These difficulties complicate efforts to automate human computation services because it becomes difficult to provide bounded task response times and accuracy guarantees.

Consequently, it is desirable to have a crowd-sourcing platform whose architecture has been designed to overcome the deficiencies of the prior art. More specifically, it would be desirable to provide a crowd-sourcing platform that recruits workers for taskings; that qualifies workers for the performance of tasks at certain levels; and that pushes posted tasks down to qualified workers.

### SUMMARY OF THE INVENTION

In some embodiments of the present invention, a system for online crowd-sourcing and for communicating with at least one requester and a crowd of workers is disclosed. Each of the at least one requester is equipped with a requester interface and a processing device for providing a task(s) to be performed and each of the workers is equipped with a worker interface and a processing device. In one aspect of the invention, the worker interface includes a web-enabled cellphone that includes, inter alia, a device that enables the worker to opt out of a next task in a priority queue.

The system includes a central controller that is adapted to communicate with each requester interface, to receive the at least one task to be performed and to provide a response thereto, and to communicate with each of the worker interfaces, to deliver task assignments and to receive responses therefrom. The central controller further includes a task assignment system and a data storage device. The task assignment system is structured and arranged to insert each of the tasks to be performed into a priority queue multiple times and, further, to push a next task in the priority queue to a selected worker. The data storage device stores information about workers, which can include a worker identification, a worker skill level, an accuracy rating, a list of historical tasks performed by the worker, and a list of historical tasks that the worker has not performed. The data storage device also stores a workflow presentation algorithm(s), e.g., a parallel workflow model, a majority vote workflow model, an iterative workflow model, a peer voting workflow model, a peer review workflow model, and any combination thereof, for identifying how to present the next task in the priority queue to selected worker.

The system also includes a payment system that is structured and arranged to determine a per task cost for each of the tasks to be performed; to collect payment for the per task cost from each of the at least one requester; and to pay each of the plurality of workers who correctly performed each of the tasks. In one aspect of the present invention, the per task cost is calculated by dividing a locally-determined minimum hourly wage by a number of tasks a discrete worker or an average worker can complete in an hour. In another aspect of the invention, an amount paid to each of the plurality of workers can be reduced to reflect a worker's historical accuracy in providing correct responses.

Other embodiments of the present invention include methods of online source-crowding via a network. The network includes a requester(s) and a plurality of workers. Each requester is equipped with a requester interface and a processing device and each worker is equipped with a worker interface and a processing device. The methods include receiving a task request from a corresponding requester; creating a priority queue of task requests from each corresponding requester; assigning a next task on the priority queue to the worker interface of selected workers; receiving one of an opt-out or a response from the worker interface of each of the selected workers; using the response from each of the selected workers to determine a final response; and transmitting the final response to the requester interface of the corresponding requester. In one aspect of the embodiment, assigning a next task includes: selecting a plurality of workers capable of performing the next task from a crowd of workers and transmitting the next task to the selected workers in accordance with a workflow presentation algorithm(s), e.g., a parallel workflow model, a majority vote workflow model, an iterative workflow model, a peer voting workflow model, a peer review workflow model, and any combination thereof. The workflow presentation algorithm(s) are further used to provide a final response. The step of creating a priority list includes inserting each task to be performed into a priority queue multiple times and assigning a next task on the priority queue to the worker interface of selected workers. The assigning step further includes identifying each available worker; ascertaining a skill level of each available workers; ascertaining an historical accuracy rating of each available worker; ascertaining historical tasks previously performed by each available worker; ascertaining historical tasks that each available worker has not performed; and evaluating an available worker's suitability for the next task using one or more of the above. In one aspect of the present invention, an available worker is not deemed suitability for the next task if the worker has previously performed the task.

Yet another aspect of the embodiment includes generating an alert message to other workers if there are not enough qualified workers to perform a discrete task.

In still another embodiment, an article of manufacture for online crowd-sourcing is disclosed. Computer-readable program portions are embedded on the article of manufacture. The program portions include instructions for receiving a task request(s) from a corresponding requester(s); creating a priority queue of task requests using the task request(s); assigning a next task on the priority queue to the worker interface of selected workers; receiving an opt-out or a response from the worker interface of each selected worker; using the response from each selected worker to determine a final response; and transmitting the final response to a requester interface of the corresponding requester. More specifically, assigning a next task includes instructions for selecting a plurality of workers capable of performing the next task from a crowd of workers and transmitting the next task to each selected worker in accordance with a workflow presentation algorithm(s), e.g., a parallel workflow model, a majority vote workflow model, an iterative workflow model, a peer voting workflow model, a peer review workflow model, and any combination thereof. The workflow presentation algorithm(s) is also used to evaluate each response from the selected workers.

In one aspect of this embodiment, instructions for creating a priority list include instructions for inserting each task to be performed into a priority queue a plurality of times. In yet another aspect, the article of manufacture includes instructions for generating an alert message to other workers if there are not enough qualified workers to perform a discrete task.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a block diagram of an illustrative embodiment of an online crowd-sourcing system architecture in accordance with the present invention;

FIG. 2 shows a block diagram of an illustrative embodiment of the MobileWorks platform of the crowd-sourcing system shown in FIG. 1 in accordance with the present invention; and

FIG. 3 shows a flow diagram of an illustrative embodiment of a method of providing online crowd-sourcing in accordance with the present invention.

### DETAILED DESCRIPTION OF THE INVENTION

An online crowd-sourcing system and platform are disclosed. The system architecture is designed to address accuracy and speed deficiencies in the prior art approaches. The platform, referred to as MobileWorks, seeks and searches a network(s) for tasks posted on crowd-sourcing websites and actively routes or “pushes” work to qualified workers selected from a pool of recruited and tested workers. The platform matches each task with a qualified worker(s) who has undergone prior programmatic testing and human review. Advantageously, discrepancies can be resolved by the top workers, i.e., managers or superusers, who play an integral role in maintaining the quality of the system and in managing other workers. Interaction between workers at the worker level led by managers or superusers permits additional non-algorithmic worker training and discussion of individual tasks. These mechanisms address the same class of tasks solved by conventional labor marketplaces while providing substantially higher accuracy, shielding requesters from the burden of quality control, providing appropriate incentivization to the workers, identifying the best worker(s) for the task, and preventing task starvation.

The terms and expressions employed herein are used as terms and expressions of description and not of limitation, and there is no intention, in the use of such terms and expressions, of excluding any equivalents of the features shown and described or portions thereof.

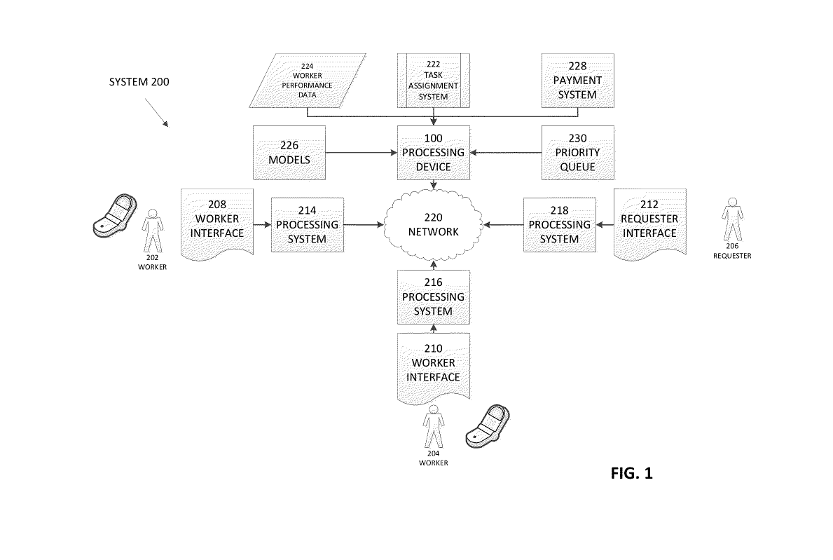

Referring to FIG. 1, an illustrative embodiment of system architecture 200 for the MobileWorks platform is shown. The system 200 involves the interaction and input of multiple workers 202 and 204, one or more requesters 206, and a processing device (“MobileWorks”) 100. The particular configuration of the system 200 depicted in FIG. 1 is used for illustration purposes only and embodiments of the invention may be practiced in other contexts. Thus, the invention is not limited to a specific number of users or systems.

The system 200 may, for example, include MobileWorks 100, a number of worker interfaces 208 and 210, a requester interface 212, processing systems 214, 216, and 218, a communications network 220, a task assignment system 222, data storage for worker performance data 224, data storage for workflow presentation models 226, a payment system 228, and a priority queue 230. The system 200 is structured and arranged to enable workers 202 and 204 to interact with worker interfaces 208 and 210, respectively, and each requester 206 to interact with a requester interface 212. The system 200 is further adapted to enable Mobileworks 100 to interact with the task assignment system 222, the data storage for the worker performance data 224, the data storage for workflow presentation models 226, the payment system 228, and the priority queue 230 to provide a crowd-sourcing platform.

According to the depicted embodiment, interfaces 208, 210, and 212 may be browser-based user interfaces served by MobileWorks 100 and may be rendered by processing systems 214, 216, and 218. In one aspect of the embodiment, the browser-based worker interfaces 208 and 210 are Web-enabled cellphones. The processing systems 214, 216, and 218 may be interconnected with one another and MobileWorks 100 via a network 220. The network 220 may include any communication network through which member computer systems may exchange data, e.g., the World, Wide Web, the Internet, an intranet, a wide area network (WAN), a local area network (LAN), and so forth.

The sundry computer systems shown in FIG. 1, which include processing systems 214, 216, and 218, MobileWorks 100, the network 220, the task assignment system 222, the payment system 228, and the priority queue 230, each may include one or more processing devices. The worker interfaces 208, 210, and 212 are processing devices that enable workers 202 and 204 and requesters 206 to interact with MobileWorks 100 via the network 220. Various aspects and functions described herein in accord with the present invention may be implemented as hardware or software on one or more processing device.

There are many examples of processing devices currently in use including network appliances, personal computers, workstations, mainframes, networked clients, servers, media servers, application servers, database servers, and web servers. Other examples of processing devices may include mobile computing devices, such as cellphones, personal digital assistants, and network equipment, such as load balancers, routers, and switches. For workers at the low end of the economic scale, low-cost, Web-enabled cellphones are envisioned as processing devices. Furthermore, aspects in accordance with the present invention may be located on a single processing system or may be distributed among a plurality of systems connected to one or more communications networks.

For example, various aspects and functions may be distributed among one or more processing systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Moreover, aspects may be implemented in software, hardware or firmware, or any combination thereof. Thus, aspects in accord with the present invention may be implemented within methods, acts, systems, system elements, and components using a variety of hardware and software configurations, and the invention is not limited to any particular distributed architecture, network, or communication protocol. To exchange data via a communication network, MobileWorks 100, the processing systems 214, 216, and 218 and network 220 itself may use various methods, protocols, and standards, including, inter alia, token ring, Ethernet, TCP/IP, UDP, HTTP, FTP, and SNMP.

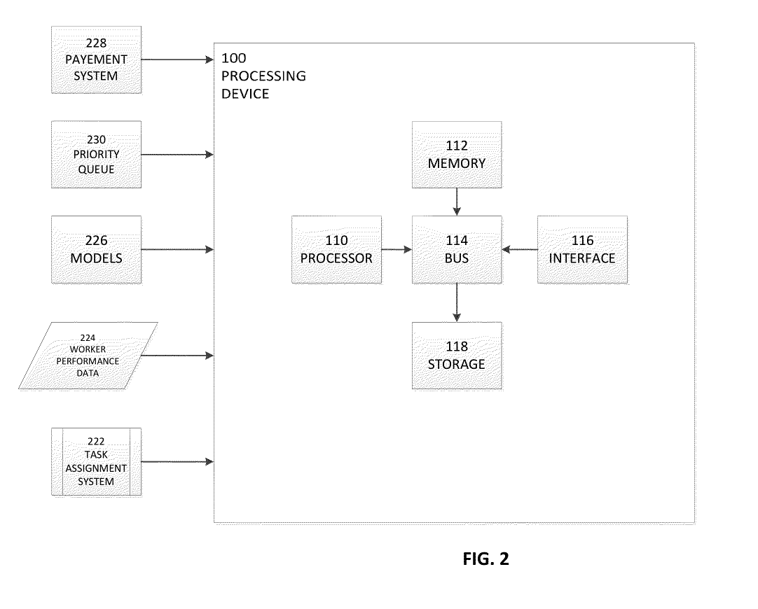

Referring to FIG. 2, an illustrative embodiment of the MobileWorks platform 100 is shown. It should be noted that various aspects and functions in accordance with the present invention may be implemented as specialized hardware or software executing in one or more processing systems. The MobileWorks platform 100 includes a processing device (“processor”) 110, a first data storage device(s) (“memory”) 112, an interface 116, and a second data storage device(s) (“storage”) 118. The processor 110 and the other elements are interconnected electrically and electronically via a bus 114.

The processor 110 may be a commercially available processor such as an Intel Core, Motorola PowerPC, MIPS, UltraSPARC, or Hewlett-Packard PA-RISC processor, but may be any type of processor or controller as many other processors, microprocessors, and controllers are available. The processor 110 is structured and arranged to perform a series of instructions, e.g., an application, an algorithm, a driver program, and the like, that result in manipulated data.

MobileWorks 100 may be a computer system including an operating system that manages at least a portion of the hardware elements included therein. Usually, a processor or controller, such as processor 110, executes an operating system which may be, for example: a Windows-based operating system, e.g., Windows 7, Windows 2000 (Windows ME), Windows XP operating systems, and the like, available from the Microsoft Corporation, a MAC OS System X operating system available from Apple Computer, one of many Linux-based operating system distributions, e.g., the Enterprise Linux operating system, available from Red Hat Inc., or a UNIX operating system available from various sources. Many other operating systems may be used, and embodiments are not limited to any particular implementation.

The processor 110 and operating system together define a processing platform for which application programs in high-level programming languages may be written. These component applications may be executable, intermediate (for example, C-) or interpreted code which communicate over a communication network (for example, the Internet) using a communication protocol (for example, TCP/IP). Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment, e.g., documents created in HTML, XML or other format that, when viewed in a window of a browser program, render aspects of a graphical-user interface or perform other functions. Furthermore, various embodiments in accordance with the present invention may be implemented as programmed or non-programmed elements, or any combination thereof. For example, a Web page may be implemented using HTML while a data object called from within the web page may be written in C++. Thus, the invention is not limited to a specific programming language. Indeed, any suitable programming language could be used.

A processing system included within an embodiment may perform functions outside the scope of the invention. For instance, aspects of the system may be implemented using an existing commercial product, such as, for example, Database Management Systems such as SQL Server available from Microsoft of Seattle, Wash., and Oracle Database from Oracle of Redwood Shores, Calif. or integration software such as Web Sphere middleware from IBM of Armonk, N.Y. However, a computer system running, for example, SQL Server may be able to support both aspects in accordance with the present invention and databases for sundry applications not within the scope of the invention.

Memory 112 may be used for storing programs and data during operation of MobileWorks 100. Thus, memory 112 may be a relatively high performance, volatile, random access memory such as a dynamic random access memory (DRAM) or static memory (SRAM). However, memory 112 may include any device for storing data, such as a disk drive or other non-volatile storage device. Various embodiments in accordance with the present invention may organize memory 112 into particularized and, in some cases, unique structures to perform the aspects and functions disclosed herein. Data storage for worker performance data 224, data storage for workflow presentation models 226, and/or the priority queue 230 can be components or elements of memory 112 or, in the alternate, can be stand-alone devices.

Components of MobileWorks 100 may be coupled by an interconnection element such as a bus 114. The bus 114 may include one or more physical busses, e.g., between components that are integrated within a same machine, but may also include any communication coupling between system elements, e.g., specialized or standard computing bus technologies such as IDE, SCSI, PCI, and InfiniBand. Thus, the bus 114 enables communications, e.g., the transfer of data and instructions, to be exchanged between MobileWorks components.

MobileWorks 100 also includes one or more interface devices 116 such as input devices, output devices, and/or combined input/output devices. Interface devices 116 enable users to employ MobileWorks 100 to exchange information and communicate with external entities, such as other processing systems 214, 216, and 218, and websites via the network 220. Interface devices 116 are adapted to receive input or to provide output. More particularly, output devices may render information for external presentation, for example, on display devices. Input devices may accept information from external sources. Examples of interface devices include keyboards, mouse devices, trackballs, microphones, touch screens, printing devices, display screens, speakers, network interface cards, and so forth.

As discussed in greater detail below, MobileWorks 100 via the task assignment system 222 is structured and arranged to receive a task(s) from at least one requester 206; to apply one or more workflow presentation models to the task(s); to create a priority list 230 of a multiplicity of received tasks; to identify multiple workers 202 and 204 to perform each task using worker performance data 224; to communicate, i.e., “push”, a task from the priority list 230 to selected workers 202 and 204; to enable the selected workers 202 and 204 to view the task; to receive transmitted responses from the multiple workers 202 and 204; to apply one or more workflow presentation models to the workers' responses; to assess and record the accuracy of each worker's response; to communicate a response of a completed task to the corresponding requester 206; and to determine payment for the completed tasks using the payment system 228. In various embodiments, the worker performance data 224 includes data about a worker's performance and qualifications from a variety of sources, e.g., educational institutions, peers, actual testing, past performance and accuracy results.

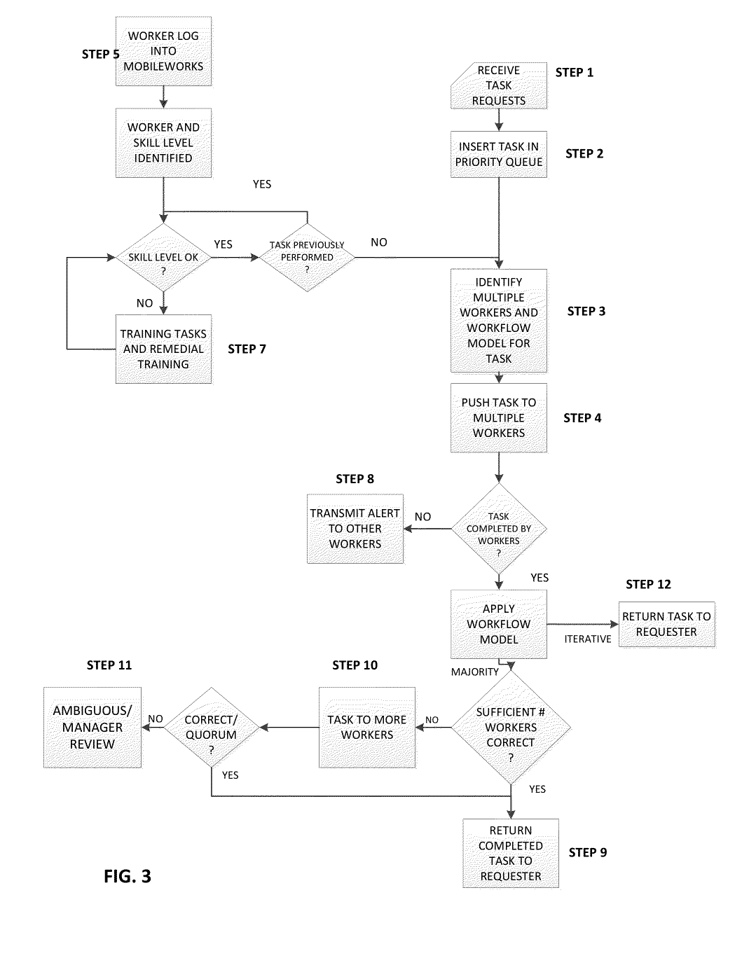

Having described a system architecture for conducting online crowd-sourcing, methods of online crowd-sourcing using such a system will now be described. Referring to FIG. 3, as previously mentioned, an active task-routing system plays a pivotal role in the present invention. The system receives requests from multiple requesters (STEP 1); inserts each task in a priority queue (STEP 2); identifies multiple workers to perform each task from the priority queue (STEP 3); and assigns, i.e., “pushes”, tasks from the priority queue (STEP 4) to the selected workers. Providing a work queue of tasks (STEP 2) affords a simple mechanism for preventing starvation, which refers to both a shortage of available tasks at the worker end and an uncompleted task(s) at the requester end. Work requests or tasks can be pushed (STEP 4) to multiple workers via MobileWorks, e.g., using a REST API, a Web dashboard, a community-designed application that pushes tasks into MobileWorks via the API, and the like. The Web interfaces and the API interfaces support similar functionality, which is to say that requesters can define instructions, e.g., using HTML, Javascript, and so forth. The API automatically generates tasks within MobileWorks that further distribute data among sub-tasks, assigning one datum to each task while assigning each task to multiple workers. Once a task is posted, requesters may observe the behavior and activity of workers working on the task, enabling the requesters to observe what issues are raised by the workers as they work through the task to completion. Advantageously, requesters may interact with workers to provide answers to worker questions for further instructions or clarification.

Preferably, requesters specify in each request or task a set of instructions, a set of answer fields, preferences for what kind of workflow they require, a set of required worker skills, and so forth. A default workflow presentation model, e.g., a parallel workflow presentation model, can be set; although requesters can opt for a different workflow presentation model, which can be selected from a drop-down menu, a list of keywords, and the like. The set of worker skills also can be selected from a drop-down menu, a list of keywords, and the like that have been prepared and made available to requesters in advance. Alternatively, requesters can define their own, customized set of desired worker skills. In some embodiments, requesters provide data that the requester desires to process instead of providing an answer-based task.

To better ensure quality responses, each submitted task (STEP 1) is inserted in the priority queue (STEP 2) multiple times for presentation and distribution to multiple workers (STEP 4). Prior to presenting the task to multiple workers, though, those workers must be identified and a workflow presentation model for the task must be selected (STEP 3). Workflow presentation models can include parallel (majority vote), iterative, peer voting or peer review models, or a combination thereof. The presentation model can be pre-selected by the requester or a default model can be assigned to the task corresponding to the task's scope. Optionally, requesters can elect to receive raw results from workers, by-passing the quality control system and/or the managerial review process.

With a parallel or majority vote workflow presentation model, a single task is presented to multiple workers at or substantially at the same time. According to the parallel or majority vote workflow presentation model, once a pre-established number of workers receiving the same task provides the same or substantially the same response to the task, then the response is presumed to be correct and the response is returned to the requester (STEP 9). If, however, the number of similar worker responses does not equal or exceed the pre-established number, then the task is provided to more workers (STEP 10) until a quorum is achieved. If no quorum is achieved without exceeding a pre-determined maximum number of workers, the task is presumed to be ambiguous and it is marked for review by managers (STEP 11).

The majority vote workflow presentation model can be modified slightly when workers are required to provide multiple answers to a single question. Although the workflow model is designed to select the single answer that is provided by a majority or pre-established number of the workers, when multiple responses from each worker for a single task are required, the workflow model can be adapted to identify intersections between a first worker's set of answers (A), a second worker's set of answers (B), and a third worker's set of answers (C). This modified parallel workflow model can be adapted to establish in advance an agreement level (n), to define how many of the workers (n) working on a particular task must agree on a unique element of the task before that unique element is added to a consensus set (U). An agreement level of two implies that at least two workers must agree on a unique element of the task for their common response to be added to the consensus set (U).

Such parallel workflow models work most effectively when there are intersecting elements in the worker sets of responses, e.g., A=B=A∩B. However, when there are no intersecting elements, i.e., A≠B, an iterative approach is preferred. The iterative approach to the parallel workflow algorithm locates intersections among each potential combination of n sets, where n refers to the agreement level. For example, assume that n=2, that there are three workers (A, B, C), and that the responses from each of the three workers are as follows:

| USER A | USER B | USER C |
|---|---|---|
| info@domain.com | info@domain.com | peter@domain.com |
| john@domain.com | support@domain.com | steve@domain.com |
| peter@domain.com | jobs@domain.com | jobs@domain.com |
| jobs@domain.com | steve@domain.com | |
| | katy@domain.com | |

The possible combinations for n=2 are (A,B), (A,C), and (B,C). The intersection of A and B (A∩B) includes the set {info@domain.com and jobs@domain.com}, the intersection of A and C (A∩C) includes the set {peter@domain.com and jobs@domain.com}, and the intersection of B and C (B∩C) includes the set {steve@domain.com and jobs@domain.com}. All intersecting elements from these comparison can then be united with the consensus set (A∩B∪A∩C∪B∩C∪U), adding only unique new elements to the consensus set (U). Hence, for the example, the consensus set (U) includes {info@domain.com, jobs@domain.com, peter@domain.com, and steve@domain.com}.

However, in order for the algorithm to converge, an upper bound of iterations is needed, for which there are two possible approaches. Either the number of iterations is fixed, e.g., as a function or multiple of the agreement level, e.g., 2n or 3n, or, alternatively, all elements in the sets that are not in the consensus set, i.e., A∪B∪C\U, are processed through a third iteration in which a worker, e.g., a manager or superuser, is shown one of the elements that is not contained in the consensus set (U) and verifies whether or not the element satisfies the instructions and should or should not be added to the consensus set. After this third iteration, the task is considered completed.

In contrast with parallel workflow presentation models, with iterative workflow presentation models, a task is provided to selected workers sequentially until the task has been acted upon by a pre-specified number of workers. The first worker receiving the task provides his/her response to the second worker and so on. Each of the workers edits the task as necessary as it is passed from worker to worker. At the end of the sequence, the response is assumed to be correct and returned to the requester (STEP 12). Peer review models (not shown), as the name suggests, use one worker, e.g., a manager or superuser, to evaluate the correctness of a response prepared by another worker or other workers.

Tasks having multiple answer dimensions, i.e., multi-dimensional tasks, present a special challenge in maintaining quality. Multi-dimensional tasks require each selected worker to provide a single response that includes multiple pieces of related information, e.g., the name, phone number, and email address of an individual. In this example, a concatenation of the name, phone number, and email address of an individual constitutes a “response field.” Because the collective information in the response fields is only of value if their inter-relationship is maintained, to arrive at a consensus, the information must be considered as one entity when compared to other responses. Hence, comparison of worker answers involves comparing a relatively long data string that contains each response field, i.e., each dimension, of the task. Problematically, this may lead to frustration among workers who, despite their best intentions and having provided a substantially correct response, might be penalized for minor differences in the format of their response string, e.g., due to typographical errors. For example, consider the results for the following multi-dimensional task:

| Worker | Answer (Price - Email Address - Name) |
|---|---|
| A | “3,999 - walter@domain.com - Walter Gibson” |
| B | “3,999 - walter@domain.com - Walter Gibson” |
| E | “3,999.00 - walter@domain.com - Walter Gibson” |
| C | “3.350 - teresa@domain.com - Teresa” |
| D | “3,350 - teresa@domain.com - Teresa” |
| E | “3,350 - teresa@domain.com - Teresa A” |

MobileWorks would identify agreement between worker A and B in connection with the “Walter” responses but would not identify agreement between A and E or between B and E due to the different notation “0.00” in the price appearing in worker E's response. As to the multiple “Teresa” responses, neither C nor D agrees with E due to the additional initial in the name field and C does not agree with D due to the different format in the price.

Accordingly, to allow for less rigid comparison for multi-dimensional answers, each answer can be compared with another answer, further computing a Levenshtein distance between the compared responses. The Levenshtein distance is a similarity metric that measures how similar two strings are to one another by determining the number of alteration or deletion operations of single characters, i.e., “strokes,” would need to be performed in order to match the strings perfectly. For example, using the “Teresa” data above, the Levenshtein distance between C and D is one, i.e., mapping the period (.) into a comma (,) while the Levenshtein distance between D and E is two, i.e. removing a space ( ) and “A” after “Teresa”. Once a Levenshtein distance is determined for each response combination, a k-nearest neighbor algorithm can be used to identify answers that exhibit the most or the greatest similarity to one another. Thus, a relative similarity of, for example, 95% as a lower bound can be used instead of an absolute, i.e., 100%, requirement. This is prudent because it is more important to the process and to the success of the process to provide response “neighbors” that are most certainly similar entries than to enforce rigidly a fixed number of answers that might substantially differ.

In the event that similar entries are established by an acceptable Levenshtein distance, a second, human iteration can be performed that asks a worker, e.g., a manager or superuser, to identify whether or not any of the displayed “substantially similar” entries corresponds to one another and, if so, the worker is prompted to effect necessary edits so that each of the entries matches the other exactly. If there are no substantially similar entries, the task is either pushed to another selected worker(s) or the task is considered completed and the requester is notified that no response was possible.

Although the parallel and iterative workflow presentation models can be used separately, this is not to say that they also cannot be combined, especially when dealing with multi-dimensional, multi-element tasks. For example, when dealing with multi-dimensional, multi-element tasks, the multi-dimensional similarity algorithm can be amended between the first and second iteration. More specifically, after the intersection of sets has been determined, a similarity analysis on all non-intersecting elements can be performed, to identify those worker responses that refer to the same entity but that deviate only to a minor degree, i.e., have a small Levenshtein distance. Finally, the hybrid workflow model would decide whether a second iteration is necessary or the task can be considered completed.

At the worker end of MobileWorks, workers enter the MobileWorks platform (STEP 5), e.g., via the network using a Web browser, a Web-enabled cellphone, and the like. Data on each entering worker is available, e.g., in worker performance data; hence, once a worker logs into MobileWorks (STEP 5), the system automatically identifies the worker as well as the worker's skill level, capabilities, and historical performance (STEP 6). Workers whose overall skill accuracy falls below a pre-determined level are assigned training tasks and/or remedial training (STEP 7) rather than being assigned any of the requests in the priority queue. For those workers who have demonstrated an acceptable skill accuracy, MobileWorks assigns him/her the next task in the queue (STEP 3) for which the worker has an appropriate skill level and which the worker has not previously performed the task. Advantageously, workers do not select their own tasks; rather, MobileWorks pushes work to the worker. As a result, workers complete tasks more efficiently and are kept busier because they do not have to spend their own time searching for suitable tasks. MobileWorks automatically pushes tasks (STEP 3) to them once the worker has entered MobileWorks (STEP 5). Advantageously, pushing tasks to available workers provides a useful guarantee to requesters that every task will be answered in time. Should a task remain near the end of the priority queue for an excessive amount of time, MobileWorks interleaves these tasks with tasks near the front of the priority queue, to prevent large jobs with many sub-tasks from deadlocking the system. More advantageously, by using a priority queue instead of a marketplace solution, MobileWorks exhibits fine-grained control over the speed at which work is completed. Moreover, work at the front of the priority queue will be completed more quickly.

In the event that work that is pushed down to a worker is not completed, e.g., due to the natural activity of workers in the system, ambiguity, and so forth, MobileWorks can generate and transmit alert messages, e.g., email messages, text messages, tweets, and the like, to other workers (STEP 8) who, for one reason or another, have not yet entered MobileWorks. Such alerts inform those un-entered workers that there are tasks available for assignment.

Although workers are not allowed to select their own tasks, a worker may, for cause, opt-out of a particular task, e.g., by selecting a “report problem” selector or button provided in the application and displayed on the worker interface. For example, workers who are unfamiliar with a task or who are confused by its instructions can opt-out, entering a cause provided in a drop-down menu or window that appears on the display device of the worker's interface after the “report problem” selector or button is selected. For the purpose of illustration and not limitation, opt-out reasons on the drop-down menu can include that the instructions were not clear, that the instructions did not cover what to do in a particular instance, that the individual links or resources were not available, and so forth. Advantageously, opt-out ensures that a response to all tasks provides some form of feedback to requesters, whether the response/feedback is a problem with ambiguity or clarity of the task or whether the response/feedback is of a nature desired from the requester. Otherwise, the task might silently starve for want of a worker to act on it. In short, even unfavorable feedback is better than no feedback at all. Tasks that are not answered except by opt-out, e.g., due to faulty design or wording, can be escalated to managers for resolution before being returned to the requester for debugging and, as necessary, re-phrasing.

Many crowd-sourcing tasks require the attention of workers having specialized skills or knowledge. Historically, automated tests or dedicated communities, e.g., 99Designs, StackOverflow, and the like, have identified expert workers. However, automated testing can be inadequate to identify an optimal worker(s) for complex skill categories such as writing, content editing or for open-ended tasks for which an automated test cannot verify quality. Notwithstanding this limitation on automated testing, requesters using online crowd-sourcing in accordance with the present invention are able to specify worker qualifications that are required to complete their tasks. If a worker with suitable qualifications is available, he/she would be assigned the task. More specifically, after a task requiring special skills is received, MobileWorks searches available information on workers, e.g., in the worker performance data, to determine whether or not the most current crowd includes workers having the requested level of expertise. If so, the task(s) are assigned to that person or those persons.

However, if the required expertise is not immediately available, MobileWorks can expand the worker crowd population to identify one or more potential workers with the level of expertise required, e.g., using the crowd population itself. This expanded search can take the form of a task universally posted to the crowd of workers, requesting referral of an individual(s) who may be able to satisfy the requirements. The referral's resume or similar document listing the referral's qualifications can be forwarded to a manager for review. The manager can require the referral to complete a preliminary task requiring the desired level of expertise satisfactorily. If the referral is brought into the network, after addressing the immediate task requiring his/her expertise, the referral can be tasked to recruit additional experts as necessary and/or to perform peer-review of future work. Because experts in a particular field typically know others with the same or similar level of expertise in the same field, a population of experts of a desired size can be expeditiously established in the crowd for future needs. Subjective testing of would-be experts can be provided to determine eligibility and suitability. However, it may be necessary to rely on the requester's expertise unless a manager(s) is capable of assessing quality for tasks for which they themselves lack a high level of fluency.

Improper incentivization, which is to say, the inability of the worker to earn a livable wage, is a major cause of worker malice and task starvation in the crowd marketplace. Task pricing tends to be excessively low in existing marketplaces, relying on a limited supply of tasks and a larger demand for the work to keep compensation low. To combat these shortcomings, MobileWorks 100 employs a pricing/payment system 228 that is structured and arranged to pay workers a per task wage that the system sets itself, which is designed to ensure that workers, on average, can earn a fair or above-market hourly wage according to local standards.

The system establishes pricing by measuring the average time (T, in minutes) required by workers to carry out a task and then calculating the number of tasks a worker can perform hourly (N=60/T). The “worker” can be an average worker or can be a discrete worker. Using local minimum wage standards ($), the system determines the cost per task (C=$/N), which will effectively allow each worker to earn an at-market or above-market wage, assuming, of course, that the worker successfully performs N tasks per hour. Knowing the wages, necessary to pay its workers, MobileWorks can negotiate and pass on a fixed, per task cost (C) to requesters. The per task cost (C) can be modified from time to time to account for tasks that take longer or shorter than normal. For example, if a requester's tasks, e.g., multiple response and/or multi-dimensional tasks, habitually require significantly more time to perform, then the per task cost (C) would be increased to reflect the disparity between local minimum wage standards ($) and task time (T). Modifications to the per task cost (C), however, would require notification of and approval by the requester prior to work continuing.

The fixed, per task cost (C) is predicated on the worker providing a correct response 100 percent of the time. However, that is not always the case. Consequently, MobileWorks is adapted to interface the payment system with the data worker performance data to adjust the pay that a worker actually receives to reflect the worker's historical accuracy. This tiered approach rewards those workers whose accuracy is superior but penalizes those workers whose accuracy has dipped below pre-established acceptable levels. For example, a worker whose accuracy level dips below 80 percent might only receive 75 percent of his total possible wages on future tasks. This approach encourages long-term attention to detail and accuracy rather than merely crunching through as many tasks as possible. Indeed, when workers realize that current incorrect answers affect his/her future take-home pay, the financial pain of inaccuracy increases. Preferably, each worker will have a profile, e.g., in the worker performance data, that will include a summary of incorrect responses. The profile and discrete responses can be rebutted or challenged, necessitating manager review, which advantageously improves accuracy.

Social and management techniques to facilitate worker-to-worker and manager-to-worker communication produce an effective working environment in crowd-sourcing platforms using the MobileWorks architecture. For example, worker error is often caused by a worker's inability to understand the stated task or when instructions fail to cover all possibilities that may arise in a specific example of a task. To remedy these shortcomings, MobileWorks can be adapted to allow workers to intercommunicate in real time. For that purpose, a chat box can be embedded in the workers' interfaces. Chat boxes are well known to the art and will not be described in great detail. Such a feature allows workers to collaborate on tasks, to suggest additional examples, to teach other workers how to use the interface, to confirm theories as to what is meant by the task, and so forth.

At the management level, high-performing members of the crowd, i.e., superusers or managers, may exercise managerial privileges and duties, providing an additional level of institutional supervision and support. Typically, superusers or managers are identified in the crowd due to their education, average accuracy, and task volume. In addition to receiving income from their own workload and for resolving ambiguous tasks on behalf of the system, managers can also earn a percentage, e.g., 10-15%, of what each worker they supervise earns. Managers can be asked to recruit new workers and can be compensated for assembling an effective team. Such peer recruitment provides a natural filter to incoming workers based on demographic profiles and likely motivation, which, assumedly, are similar to those of the recruiting manager. Managers also exercise a training function, to train workers how to carry out tasks. Training can be one-on-one, by screencast, via email, and so forth. At workers' insistence, much of the training can be embedded on each worker's interface.

Having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What I claim is:

1. A system for online crowd-sourcing and for communicating with at least one requester, each of the at least one requester having a requester interface and a processing device, and with a plurality of workers, each of the plurality of workers having a worker interface and a processing device, the system comprising:
a central controller that communicates with each requester interface, to receive at least one task to be performed and to provide a response thereto, and with each worker interface, to assign at least one task to at least one selected worker and to receive a response therefrom, the central controller including:
a task assignment system that is structured and arranged to insert each of the received at least one task to be performed into a priority queue multiple times and to push a next task in the priority queue to a selected worker based on information about said selected worker; and
a data storage device for storing information about the plurality of workers, said information including a worker identification, a worker skill level, and a worker accuracy rating.

2. The system as recited in claim 1, wherein information about the plurality of workers further includes a list of historical tasks performed by the worker and a list of historical tasks that the worker has not performed.

3. The system as recited in claim 1, wherein the worker interface and processing device include a selector to opt-out of the next task in the priority queue.

4. The system as recited in claim 1 further comprising a data storage device for storing at least one workflow presentation algorithm for identifying how to present the next task in the priority queue to the selected worker.

5. The system as recited in claim 5, wherein the at least one workflow presentation algorithm is selected from the group consisting of: a parallel workflow model, a majority vote workflow model, an iterative workflow model, a peer voting workflow model, a peer review workflow model, and any combination thereof.

6. The system as recited in claim 1 further comprising a payment system that is in communication with the central controller and that is structured and arranged to determine a per task cost for each task to be performed; to collect payment of the per task cost from each of the at least one requester; and to remunerate each selected worker who correctly performs each task to be performed.

7. The system as recited in claim 6, wherein the per task cost is calculated by dividing a locally-determined minimum hourly wage by a number of tasks a discrete worker can complete in an hour.

8. The system as recited in claim 6, wherein an amount paid to each of the plurality of workers is adjusted to reflect a worker's historical accuracy in providing correct responses.

9. The system as recited in claim 1, wherein the worker interface includes at least one web-enabled mobile or cellular telephone.

10. A method of online source-crowding via a network, the network having at least one requester, each of the at least one requester having a requester interface and a processing device and a plurality of workers, each of the plurality of workers having a worker interface and a processing device, the method comprising:
receiving a task request from a corresponding requester from the at least one requester;
creating a priority queue of task requests;
assigning a next task on the priority queue to the worker interface of selected workers;
receiving either an opt-out or a response from the worker interface of each of the selected workers;
using the response from each of the selected workers to determine a final response; and
transmitting the final response to the requester interface of the corresponding requester.

11. The method as recited in claim 10, wherein assigning a next task includes:
selecting a plurality of workers capable of performing the next task from a crowd of workers; and
transmitting said next task to the selected workers from the plurality of workers in accordance with at least one workflow presentation algorithm.

12. The method as recited in claim 11, wherein the at least one workflow presentation algorithm is selected from the group consisting of: a parallel workflow model, a majority vote workflow model, an iterative workflow model, a peer voting workflow model, a peer review workflow model, and any combination thereof.

13. The method as recited in claim 10, wherein creating a priority list includes inserting each task to be performed into a priority queue a plurality of times.

14. The method as recited in claim 10, wherein assigning a next task on the priority queue to the worker interface of selected workers includes:
identifying a plurality of available workers;
ascertaining a skill level of each of the plurality of available workers;
ascertaining an historical accuracy rating for each of the plurality of available workers;
ascertaining historical tasks previously performed by each of the plurality of available workers;
ascertaining historical tasks that each of the plurality of available workers has not performed; and
evaluating an available worker's suitability for the next task using at least one of the above.

15. The method as recited in claim 14, wherein the available worker is not deemed suitability for the next task if said next task is included among the historical tasks previously performed by said available worker.

16. The method as recited in claim 10 further comprising generating an alert message to other workers if there are not enough qualified workers available to perform a discrete task.

17. The method as recited in claim 10, wherein using the response from each of the selected workers includes applying at least one workflow presentation algorithm to said responses.

18. The method as recited in claim 17, wherein the at least one workflow presentation algorithm is selected from the group consisting of: a parallel workflow model, a majority vote workflow model, an iterative workflow model, a peer voting workflow model, a peer review workflow model, and any combination thereof.

19. An article of manufacture having computer-readable program portions embedded thereon for performing online crowd-sourcing, the program portions comprising instructions for:
receiving at least one task request from a plurality of corresponding requesters;
creating a priority queue of task requests;
assigning a next task on the priority queue to a worker interface of each selected worker;
receiving either an opt-out or a response from the worker interface of each selected worker;
using the response from each selected worker to determine a final response; and
transmitting the final response to a requester interface of the corresponding requester.

20. The article of manufacture as recited in claim 19, wherein assigning a next task includes instructions for:
selecting a plurality of workers capable of performing the next task from a crowd of workers; and
transmitting said next task to each selected worker from the plurality of workers in accordance with at least one workflow presentation algorithm.

21. The article of manufacture as recited in claim 20, wherein the at least one workflow presentation algorithm is selected from the group consisting of: a parallel workflow model, a majority vote workflow model, an iterative workflow model, a peer voting workflow model, a peer review workflow model, and any combination thereof.

22. The article of manufacture as recited in claim 19, wherein creating a priority list includes instructions for inserting each task to be performed into a priority queue a plurality of times.

23. The article of manufacture as recited in claim 19 further comprising instructions for generating an alert message to other workers if there are not enough qualified workers to perform a discrete task.

24. The article of manufacture as recited in claim 19, wherein using the response from each of the selected workers includes instructions for applying at least one workflow presentation algorithm to said responses.

25. The article of manufacture as recited in claim 24, wherein the at least one workflow presentation algorithm is selected from the group consisting of: a parallel workflow model, a majority vote workflow model, an iterative workflow model, a peer voting workflow model, a peer review workflow model, and any combination thereof.
